(19) United States
(12) Patent Application Publication
(10) Pub. No.: US 2026/0328619 A1
(43) Pub. Date: Oct. 22, 2026

(54) CHEMICAL SENSING USING COMPRESSED ULTRAFAST LASER

(71) Applicant: Applied Materials, Inc., Santa Clara, CA (US)

(72) Inventor: TIMOTHY CHEN, Los Altos, CA (US)

(21) Appl. No.: 19/183,049

(22) Filed: Apr. 18, 2025

(51) Int. Cl. G01J 3/42; G01J 3/02

(52) U.S. Cl. CPC G01J 3/42; G01J 3/0218; G01J 2003/423

(57) ABSTRACT

Embodiments described herein relate to an apparatus that includes a laser module. In an embodiment, the laser module includes a laser configured to emit a laser beam at a first wavelength and a first pulse width, a pulse width temporal compressor optically coupled to the laser, where the pulse width temporal compressor is configured to reduce the first pulse width of the laser beam to a second pulse width that is shorter than the first pulse width, and a hollow core fiber optically coupled to the pulse width temporal compressor, where the hollow core fiber is configured to be filled with a gas, and where the laser beam is configured to generate a resonant dispersive wave with a second wavelength that is shorter than the first wavelength. In an embodiment, the apparatus further includes an optical detector.

### BACKGROUND

### 1) Field

Embodiments relate to the field of semiconductor manufacturing and, in particular, chemical sensing during semiconductor processing using compressed ultrafast lasers.

### 2) Description of Related Art

In semiconductor manufacturing, radicals are often used in order to process substrates (e.g., for etching, deposition, treatments, and/or the like). Currently, one of the most sensitive forms of radical detection (e.g., to detect concentrations of H, N, O, Br, and/or Cl radicals) is through the use of a two-photon absorption laser induced fluorescence (TALIF) technique. In the TALIF technique, two deep ultraviolet (DUV) photons are absorbed by the radical, and the radical then emits a visible photon as fluorescence. High intensity femtosecond (fs) lasers provide the best sensitivity (e.g., tens of μTorr) but they are costly and bulky. For example, lasers suitable for such techniques may cost hundreds of thousands of dollars and have footprints that are over 20 square feet.

### SUMMARY

Embodiments described herein relate to an apparatus that includes a laser module. In an embodiment, the laser module includes a laser configured to emit a laser beam at a first wavelength and a first pulse width, a pulse width temporal compressor optically coupled to the laser, where the pulse width temporal compressor is configured to reduce the first pulse width of the laser beam to a second pulse width that is shorter than the first pulse width, and a hollow core fiber optically coupled to the pulse width temporal compressor, where the hollow core fiber is configured to be filled with a gas, and where the laser beam is configured to generate a resonant dispersive wave with a second wavelength that is shorter than the first wavelength. In an embodiment, the apparatus further includes an optical detector.

Embodiments described herein relate to a processing tool that includes a chamber, and a two-photon absorption laser induced fluorescence (TALIF) sensor that is optically coupled to the chamber. In an embodiment, the TALIF sensor includes a laser module configured to emit a laser beam with a tunable wavelength. In an embodiment, the laser module includes a laser, a laser pulse width temporal compressor, and a hollow core fiber, where the hollow core fiber is configured to be filled with a gas. In an embodiment, the TALIF sensor further includes an optical detector.

Embodiments described herein relate to a processing tool that includes a chamber, and a two-photon absorption laser induced fluorescence (TALIF) sensor coupled to the chamber. In an embodiment, the TALIF sensor includes a laser module that is configured to emit a tunable laser beam with a wavelength that is less than 400 nm and a pulse width that is less than 20 fs. In an embodiment the TALIF sensor further includes an optical detector.

### BRIEF DESCRIPTION OF THE DRAWINGS

FIG. 1A is a schematic illustration of a laser module for converting a laser beam to a deep ultraviolet (DUV) wavelength with a short pulse width, in accordance with an embodiment.

FIG. 1B is a schematic illustration of a laser module for converting a laser beam to a DUV wavelength with a short pulse using a pulse width temporal compressor and a hollow core fiber, in accordance with an embodiment.

FIG. 1C is a schematic illustration of a laser module for converting a laser beam to a DUV wavelength with a short pulse using a pulse width temporal compressor, a hollow core fiber, and a prism compressor, in accordance with an embodiment.

FIG. 1D is a schematic illustration of a laser module for converting a laser beam to a DUV wavelength with a short pulse using a pulse width temporal compressor, a hollow core fiber, and a second harmonic generator (SHG), in accordance with an embodiment.

FIG. 1E is a schematic illustration of a laser module for converting a laser beam to a DUV wavelength with a short pulse using a four wave mixing process in a gas-filled hollow core fiber to obtain a fifth harmonic of the input wavelength, in accordance with an embodiment.

FIG. 2A is a schematic illustration of a processing tool that comprises a chamber with a two-photon absorption laser induced fluorescence (TALIF) sensor with a laser module that includes a pulse width temporal compressor and a hollow core fiber for wavelength modulation, in accordance with an embodiment.

FIG. 2B is a schematic illustration of a processing tool that comprises a chamber with TALIF sensor that is external to the processing tool, in accordance with an embodiment.

FIG. 2C is a schematic illustration of a processing tool that comprises a chamber with a TALIF sensor with an optical detector that is optically coupled to the chamber by a plurality of optical cables with different lengths, in accordance with an embodiment.

FIG. 2D is a schematic illustration of a processing tool that comprises a chamber with a TALIF sensor with a plurality of optical detectors for uniformity measurements within the chamber, in accordance with an embodiment.

FIG. 2E is a schematic illustration of a processing tool that comprises a chamber with a TALIF sensor and a probe laser, in accordance with an embodiment.

FIG. 3 illustrates a block diagram of an exemplary computer system that may be used in conjunction with a processing tool, in accordance with an embodiment.

### DETAILED DESCRIPTION

Embodiments described herein include systems and processes for chemical sensing during semiconductor processing using compressed ultrafast lasers. In the following description numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

As noted above, the ability to measure radical concentrations with a semiconductor processing chamber allows for improved control of the processing outcomes. For example, the knowledge of the radical concentrations may allow for a more well controlled and uniform etching process. Additionally, if the actual concentration of radical species within the chamber is known, it allows for improved matching between chambers.

Currently, the most accurate way to measure radical species within a chamber is the use of a two-photon absorption laser induced fluorescence (TALIF) technique. In the TALIF technique, two deep ultraviolet (DUV) photons are absorbed by the radical, and the radical then emits a visible photon as fluorescence. An intensity of the fluorescence may be measured by an optical sensor, and the intensity of the fluorescence may be correlated to a concentration of radicals in the chamber. That is, a quantitative measure of radicals species may be provided through the use of a TALIF technique. High intensity DUV femtosecond (fs) lasers provide the best sensitivity (e.g., tens of μTorr) but they are costly and bulky. For example, lasers suitable for such techniques may cost hundreds of thousands of dollars and have footprints that are over 20 square feet. Accordingly, it is not generally feasible to integrate TALIF sensors across an entire high volume manufacturing (HVM) environment that includes many different chambers.

As such, embodiments disclosed herein include the use of TALIF sensors that use a laser module that includes a less expensive laser with a longer wavelength and longer pulse width. In an embodiment, the laser module may further comprise components that allow for the pulse width to be compressed (e.g., shortened), and the wavelength to be reduced to an ultraviolet (UV) or DUV wavelength (e.g., less than approximately 400 nm). Such lasers (e.g., a 1030 nm center wavelength with a pulse width of about 200 fs to about 1,500 fs) are significantly less expensive. Additionally, these laser modules may have smaller footprints (e.g., by a factor of five or more) than existing solutions that are used to convert longer wavelength laser beams to the targeted DUV wavelengths (e.g., with nonlinear crystals and/or optical parametric amplifiers (OPAs)). Accordingly, it is more economically and logistically feasible to integrate TALIF sensors into a plurality of chambers within an HVM semiconductor manufacturing environment.

In an embodiment, the laser module used for the TALIF sensors may also allow for an output laser beam that has a tunable wavelength. This allows for the TALIF sensor to be tuned to detect different radicals. That is, different radical species may absorb photons at different wavelengths. The ability to tune to different wavelengths allows for multiple different radical species to be monitored with a single TALIF sensor. For example, H radicals absorb photons at 205.08 nm, N radicals absorb photons at 206.65 nm, O radicals absorb photons at 225.59 nm, Cl radicals absorb photons at 233.3 nm, F radicals absorb photons at 170 nm, and Br radicals absorb photons at 252.59 nm. As such, some embodiments may allow for a tunable wavelength between approximately 170 nm and approximately 400 nm.

In an embodiment, the wavelength of the laser may be modified through the use of a hollow core fiber that is filled with a gas (e.g., Ar, N₂O, He, Ne, etc.). The laser that is input into the hollow core fiber may generate a resonant dispersive wave depending on the gas and the pressure of the gas within the hollow core fiber. Accordingly, by modulating the pressure of the gas within the hollow core fiber (e.g., between approximately 0.1 bar and approximately 5.0 bar) the frequency of the laser beam output from the laser module may be controlled.

In an embodiment, the pulse width of the laser may be compressed through any suitable pulse width temporal compressor solution or combination of pulse width temporal compressor solutions. Some pulse width temporal solutions that may be used may include a multi-pass cell (e.g., a cascaded multi-pass cell), a series of dielectric plates (e.g., a multi-plate cell), chirped mirrors, and/or a gas filled hollow core fiber.

In an embodiment, the TALIF sensor may be integrated with a chamber using any number of setups. In a first embodiment, a single optical detector may be used in order to measure radical species concentrations. In other embodiments, a plurality of optical detectors may be used in order to measure radical species at different locations within a chamber (e.g., to provide radical concentration uniformity information). The TALIF sensor may be integrated into a vacuum environment in order to limit dispersion of the laser output before entering the chamber. Other embodiments may include prism compressor (e.g., a folded prism compressor) in order to fix dispersions related to the laser beam passing through an optical window into the chamber. In yet another embodiment, the processing tool may also comprise a probe laser in addition to the TALIF sensor. Such embodiments may allow for alternative optical monitoring of the chamber environment, such as coherent Raman scattering analysis.

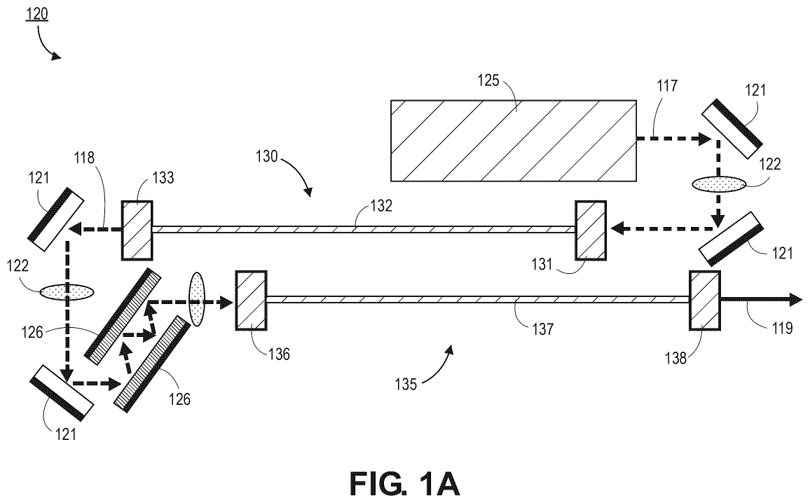

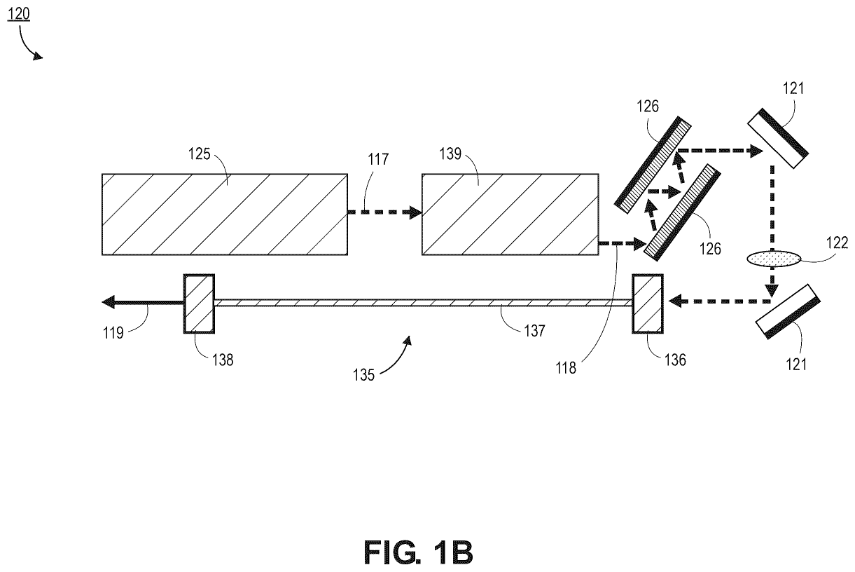

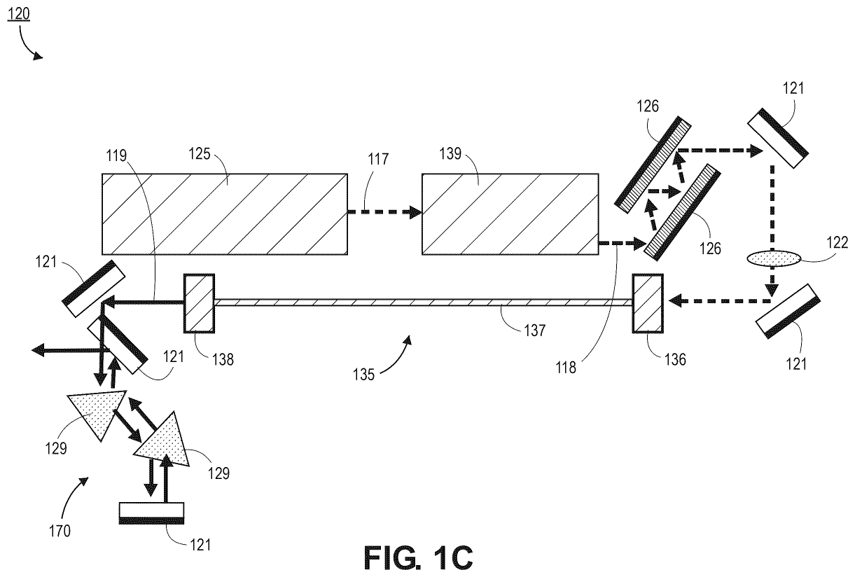

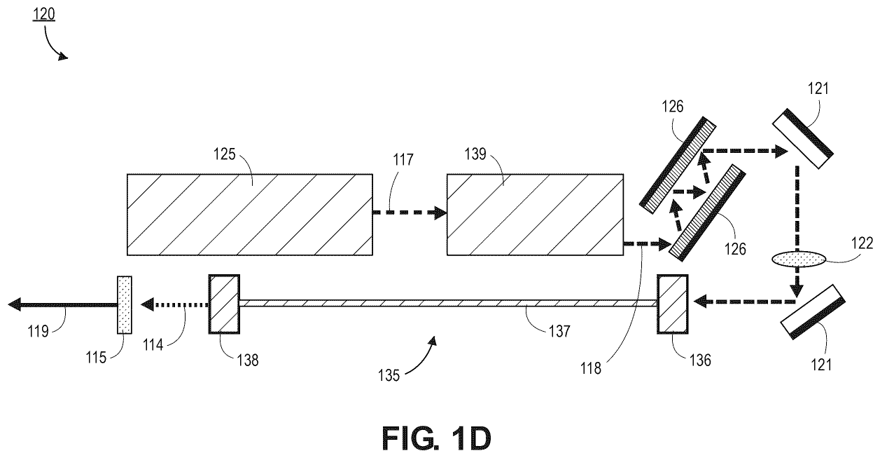

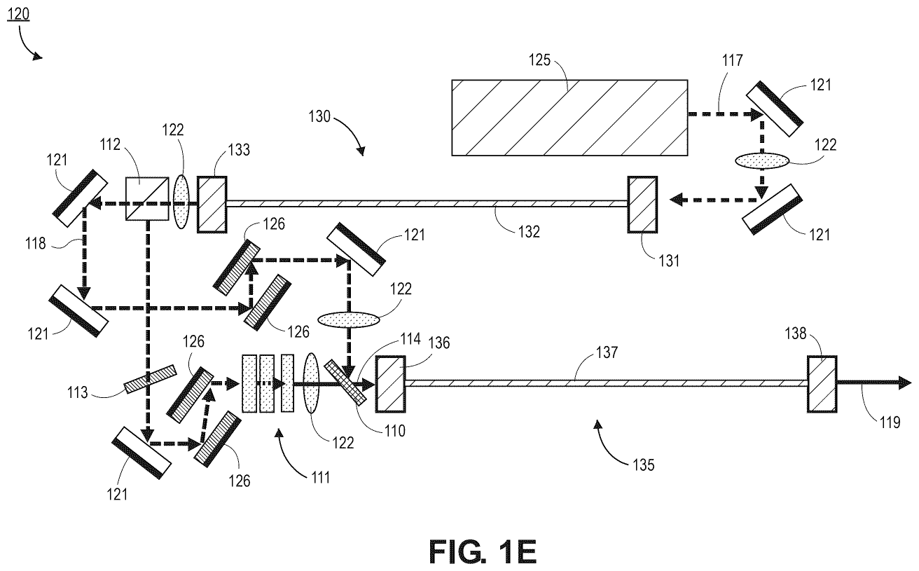

Referring now to FIG. 1A-1E, a series of schematic illustrations depicting various laser modules 120 that may be used for TALIF sensing is shown, in accordance with an embodiment. An input laser 125 may be provided for each of the laser modules 120. The input laser 125 may be a relatively inexpensive laser compared to the high performance DUV lasers typical of TALIF sensing systems. For example, the input laser 125 may have a wavelength in the visible spectrum or the near infrared (NIR) spectrum. In one embodiment, the input laser 125 may have a 1030nm center wavelength. The input laser 125 may have a pulse width of about 200 fs to about 1,500 fs.

The input laser 125 may also have a pulse repetition rate of approximately 100 kHz or more. Such high repetition rates may be significantly higher than those of existing DUV lasers typical of TALIF sensing systems. As such, higher sensitivity levels through averaging process may be used to deliver sensitivities as low as 1 μTorr. Single shot sensitivity (without averaging) may be between approximately 10 μTorr and approximately 30 μTorr when such high repetition rates are used. Fast repetition rates may also allow for fast (e.g., substantially real-time) diagnostics of the process chamber.

As can be appreciated, the longer wavelength and pulse width of the input laser 125 renders the input laser 125 incompatible with TALIF techniques. However, the output of such input laser 125 can be modified through the use of a laser pulse width temporal compressor and a wavelength reduction process in order to provide an output laser beam that is in the DUV spectrum with a suitable pulse width for TALIF sensing.

Referring now to FIG. 1A, a schematic illustration of a laser module 120 is shown, in accordance with an embodiment. In an embodiment, the laser module 120 may comprise an input laser 125 that produces a laser beam 117. The laser beam 117 may be routed to a first hollow core fiber 130 by any number of optical mirrors 121 and/or lenses 122. The first hollow core fiber 130 may comprise a hollow core 132 that is provided between an input coupler 131 and an output coupler 133. The first hollow core fiber 130 may be filled with a gas. The choice of the gas and a pressure of the gas may be used in order to convert the laser beam 117 with a first pulse width to a laser beam 118 with a second pulse width. That is, the first hollow core fiber 130 may be considered a laser pulse width temporal compressor. In an embodiment, the gas within the hollow core 132 may comprise N₂O, CO₂, N₂, or the like. In an embodiment, a pressure of the gas within the hollow core 132 may be between approximately 1 bar and approximately 5 bar.

In an embodiment, the laser beam 117 with the first pulse width may be between approximately 200 fs and approximately 1,500 fs, and the laser beam 118 with the second pulse width may be approximately 20 fs or less. The temporal compression of the pulse width may also result in a reduction in the intensity of the laser from approximately 200 μJ or higher to between approximately 50 μJ and approximately 150 μJ. In an embodiment, the temporal compression of the pulse width may be further reduced through the use of one or more negatively chirped mirrors 126.

In an embodiment, the laser beam 118 may be optically coupled to a second hollow core fiber 135. The second hollow core fiber 135 may comprise a hollow core 137 between an input 136 and an output 138. In an embodiment, the second hollow core fiber 135 may be filled with a gas that is used to generate a resonant dispersive wave that can result in a reduction in the wavelength of a laser beam 119 that is output from the laser module 120. For example, the laser beam 119 may have a wavelength that is approximately 400 nm or less. In an embodiment, the choice of the gas in the hollow core 137 and the pressure of the gas may be set to provide a desired wavelength for the laser beam 119. In an embodiment, the gas may comprise Ne, Ar, He, or the like, and a pressure of the gas may be between approximately 0.1 bar and approximately 5.0 bar. In some embodiments, the pressure in the hollow core 137 may be controllable so that the wavelength of the laser beam 119 can be changed during operation in order to determine the concentration of different radical species within a chamber. For example, the pressure of the gas may be controlled to set a wavelength of the laser beam 119 to detect one or more of H radicals (e.g., at 205.08 nm), N radicals (e.g., at 206.65 nm), O radicals (e.g., at 225.59 nm), Cl radicals (e.g., at 233.3 nm), F radicals (e.g., at 170 nm), and/or Br radicals (e.g., at 252.59 nm). In an embodiment, the wavelength reduction through the second hollow core fiber 135 may also reduce the intensity of the laser beam 119 to approximately 5.0 μJ or lower (e.g., between approximately 0.5 μJ and approximately 5.0 μJ).

Referring now to FIG. 1B, a schematic illustration of a laser module 120 is shown, in accordance with an alternative embodiment. The laser module 120 in FIG. 1B may be similar to the laser module 120 in FIG. 1A, with the exception of the laser pulse width temporal compressor. For example, instead of using a first hollow core fiber to compress the pulse width, the laser module 120 in FIG. 1B may use a compression cell 139 to reduce the pulse width of the first laser beam 117 to a shorter pulse width in the laser beam 118. The compression cell 139 may comprise a multi-pass cell (e.g., a cascaded multi-pass cell), and/or a series of dielectric plates (e.g., a multi-plate cell). In some embodiments, the laser beam 118 may be routed through a chirped mirror 126 setup before reaching the hollow core fiber 135 in order to reduce the pulse width.

Referring now to FIG. 1C, a schematic illustration of a laser module 120 is shown, in accordance with an alternative embodiment. The laser module 120 in FIG. 1C may be similar to the laser module 120 in FIG. 1B, with the addition of a prism compressor 170 after the hollow core fiber 130. The inclusion of the prism compressor 170 may be used in order to correct dispersion of the laser beam 119 as it passes through optical windows after leaving the laser module 120 (e.g., as the laser beam 119 enters a chamber). In the illustrated embodiment, the prism compressor 170 is a folded prism compressor with a pair of optically coupled prisms 129. Though, it is to be appreciated that the laser module 120 may comprise any suitable dispersion correction optics.

Referring now to FIG. 1D, a schematic illustration of a laser module 120 is shown, in accordance with an alternative embodiment. The laser module 120 in FIG. 1D is similar to the laser module 120 in FIG. 1B, with the addition of a second harmonic generator (SHG) 115 that is optically coupled to an output 138 of the hollow core fiber 135. In an embodiment, the output laser beam 114 may not be at the desired wavelength to implement TALIF sensing. As such, an SHG 115 may be provided in order to generate the second harmonic of the laser beam 114 in order to provide a laser beam 119 with the desired wavelength (e.g., less than approximately 400 nm). In an embodiment, the SHG 115 may comprise a beta barium borate (BBO) crystal or the like.

Referring now to FIG. 1E, a schematic illustration of a laser module 120 is shown, in accordance with an alternative embodiment. In an embodiment, the laser module 120 in FIG. 1E may utilize a four wave mixing process in a gas-filled hollow core fiber to obtain a fifth harmonic of the input wavelength. In such an embodiment, the laser beam 117 from the input laser 125 may be divided by five to provide an output laser beam 119 at a desired wavelength.

In an embodiment, the output laser beam 118 from a first hollow core fiber 130 may be split by a beam splitter 112. A first split beam may pass through a tuning bandpass filter 113 before reaching chirped mirrors 126 and a waveplate 111 with an SHG and a third harmonic generator (THG). The second split beam may pass through chirped mirrors 126 before being recombined at a combiner 110 to produce a laser beam 114. The laser beam 114 may be fed into a second hollow core fiber 135 to produce the final reduction to the desired wavelength.

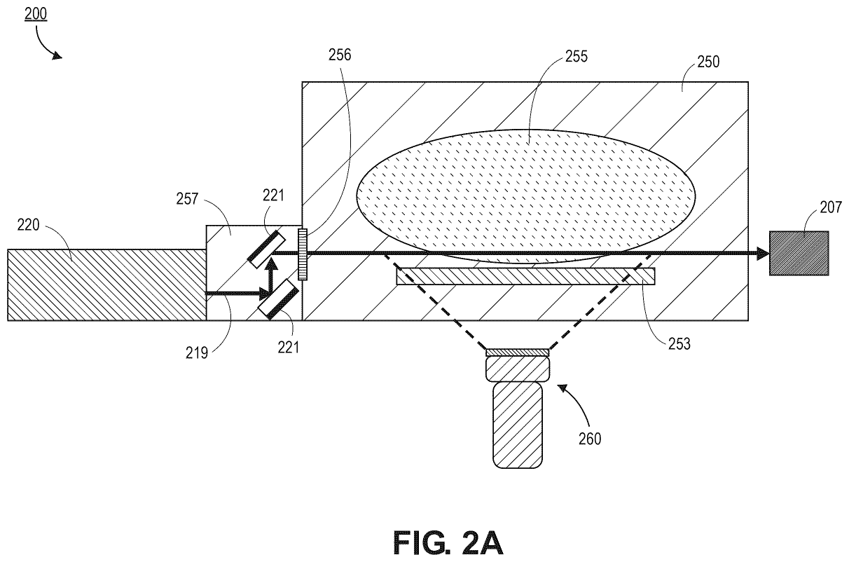

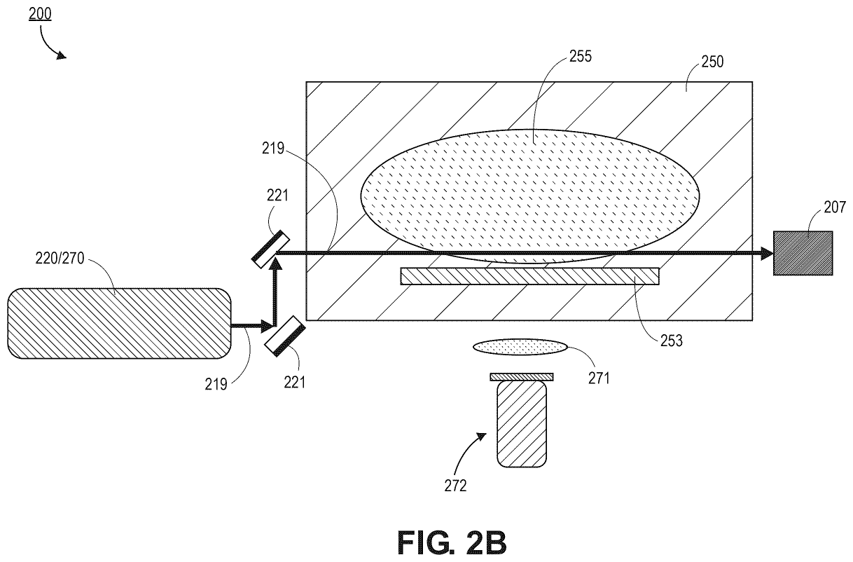

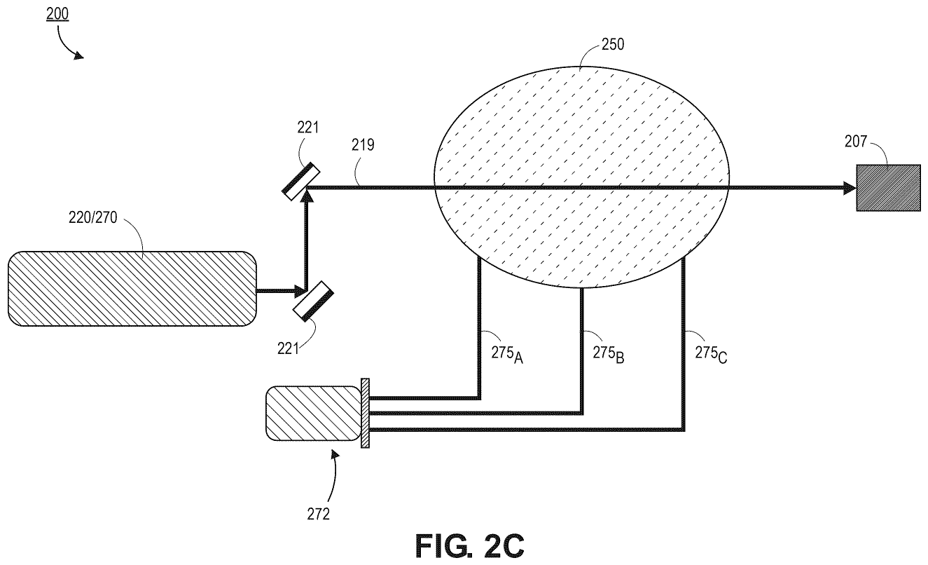

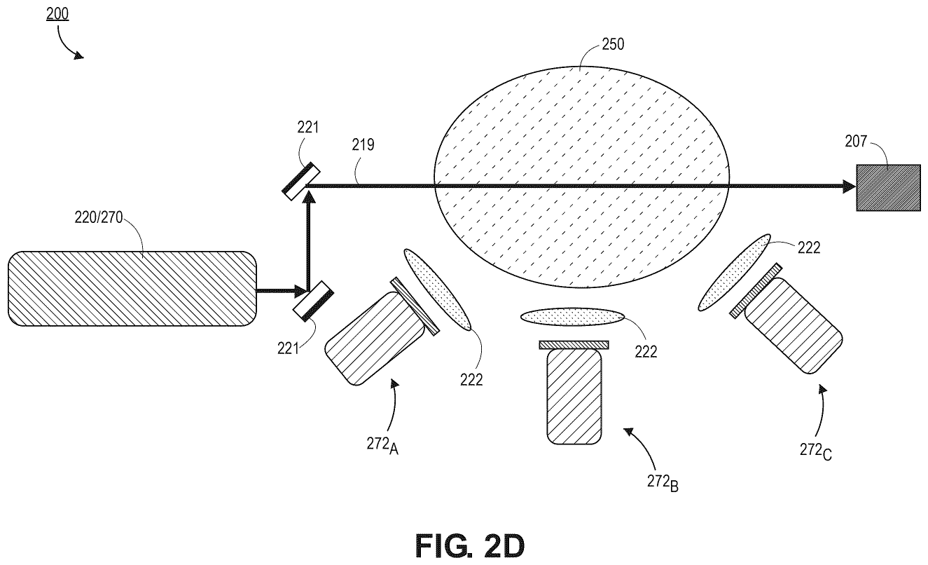

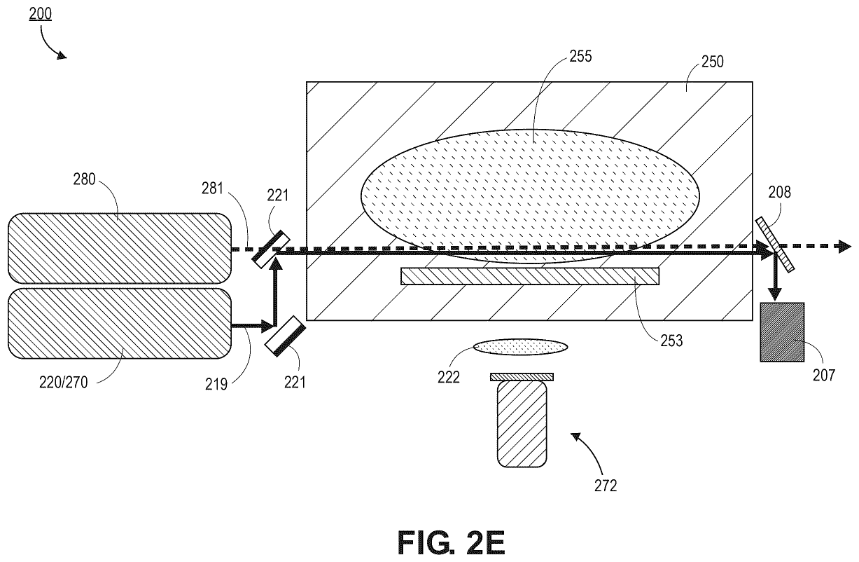

Referring now to FIG. 2A-2E, a series of schematic illustrations of processing tools 200 is shown, in accordance with an embodiment. The processing tools 200 may each comprise a chamber 250. The chamber 250 may be a vacuum chamber, such as a chamber suitable for supporting a plasma 255, used to process a substrate (not shown) that may be supported on a pedestal, chuck 253, or the like. In an embodiment, radical species within the chamber 250 may be monitored with a TALIF sensor that comprises a laser module 220. The laser modules 220 in FIG. 2A-2E may be similar to any of the laser modules 120 described in greater detail herein.

Referring now to FIG. 2A, a schematic illustration of a processing tool 200 is shown, in accordance with an embodiment. In an embodiment, the laser module 220 may have an output laser beam 219 with a pulse width and wavelength suitable for TALIF sensing. In an embodiment, the output laser beam 219 may be provided within a vacuum environment 257. For example, one or more mirrors 221 may route the laser beam 219 from the laser module 220 to the window 256 of the chamber 250 while in the vacuum environment 257. This allows for the window 256 into the main chamber 250 to be relatively thin since there is minimal pressure difference across the window 256. The use of a thin window 256 may minimize dispersion of the laser beam 219 as it passes into the chamber 250.

In an embodiment, the laser beam 219 may pass through the interior of the chamber 250 and terminate at a beam dump 207. The laser beam 219 may interact with radicals within the chamber 250 in order to generate fluorescence that can be measured with an optical sensor 260. In an embodiment, the optical sensor 260 may comprise a gated intensified camera, a photo multiplier tube (PMT) or the like. In some embodiments, the optical sensor 260 may also comprise a filter, such as a bandpass filter or the like.

Referring now to FIG. 2B, a schematic illustration of a processing tool 200 is shown, in accordance with an additional embodiment. The processing tool 200 in FIG. 2B may be similar to the processing tool 200 in FIG. 2A, with the exception of the optical coupling of the laser module 220 to the chamber 250. In FIG. 2B, the laser beam 219 passes through atmosphere before entering the chamber 250. As such, a window (not shown) into the chamber 250 needs to be thicker to accommodate the pressure difference across the window. This may lead to significant dispersion of the laser beam 219. Accordingly, a prism compressor 270 may be integrated with the laser module 220 in order to accommodate the dispersion. The prism compressor 270 may be similar to the prism compressor 170 described herein. For example, the prism compressor 270 may be a folded prism compressor. In an embodiment, the optical sensor 272 may also comprise a lens 271, a bandpass filter, and/or the like.

Referring now to FIG. 2C, a schematic illustration of a processing tool 200 is shown, in accordance with an additional embodiment. In the embodiment shown in FIG. 2C, the chamber 250 is seen from above. As shown, a plurality of optical fibers 275_{A}-275_{C} are optically coupled to the chamber 250. The optical fibers 275_{A}-275_{C} may each be optically coupled to a single optical sensor 272. In order to differentiate the signals from each optical fiber 275_{A}-275_{C}, the optical fibers 275_{A}-275_{C} may each have different lengths. The different lengths of the optical fibers 275_{A}-275_{C} allow for a time delay between each signal that can be used to isolate the optical signal provided along each of the optical fibers 275_{A} 275_{C}.

As shown, the optical fibers 275_{A}-275_{C} may be arranged around a perimeter of the chamber 250. The distribution of the optical fibers 275_{A}-275_{C} around the perimeter of the chamber 250 allow for a measurement of radical concentrations throughout different regions of the chamber 250. This allows for radical concentration uniformity measurements that may be used to improve processing uniformity. In the illustrated embodiment, a set of three optical fibers 275_{A}-275_{C} are shown as one example. However, it is to be appreciated that any number of optical fibers 275 may be optically coupled between the chamber 250 and the optical sensor 272.

Referring now to FIG. 2D, a schematic illustration of a processing tool 200 is shown, in accordance with an additional embodiment. In the embodiment shown in FIG. 2D, the chamber 250 is seen from above. As shown, a plurality of optical sensors 272_{A}-272_{C} may be optically coupled (e.g., with lenses 222 or the like) to the chamber 250. As shown, the optical sensors 272_{A}-272_{C} may be distributed around a perimeter of the chamber 250. The distribution of the optical sensors 272_{A}-272_{C} around the perimeter of the chamber 250 allow for a measurement of radical concentrations throughout different regions of the chamber 250. This allows for radical concentration uniformity measurements that may be used to improve processing uniformity. In the illustrated embodiment, a set of three optical sensors 272_{A}-272_{C} are shown as one example. However, it is to be appreciated that any number of optical sensors 272 may be optically coupled to the chamber 250.

Referring now to FIG. 2E, a schematic illustration of a processing tool 200 is shown, in accordance with an additional embodiment. The processing tool 200 in FIG. 2E may be similar to the processing tool 200 in FIG. 2B, with the addition of a probe laser 280 that is optically coupled to the chamber 250. In an embodiment, the probe laser 280 may provide a different wavelength laser that may be used to investigate additional parameters and/or conditions within the chamber 250. For example, a laser beam 281 may be coupled into the chamber 250 and pass through a filter 208 towards a spectrometer (not shown) or other optical sensor. In some embodiments, the probe laser 280 and the spectrometer may be used to implement coherent Rahman scattering analysis of chamber 250 and/or plasma conditions. In the illustrated embodiment, the probe laser 280 is added into a processing tool similar to the one shown in FIG. 2B. Though, it is to be appreciated that a probe laser 280 may be added to any of the processing tools 200 described in greater detail herein.

It is to be appreciated that the processing tools 200 described in greater detail herein allow for quantitative measurements of radical concentrations within the chamber 250. Since quantitative measurements are able to be made, embodiments enable chamber matching between different chambers (e.g., within a single processing tool or between different processing tools). As such, the chamber matching throughout a semiconductor manufacturing facility (or fab) may be improved. Further, since lower cost and more compact hardware is used for the TALIF sensing, TALIF sensing is more economically integrated into chambers across the fab.

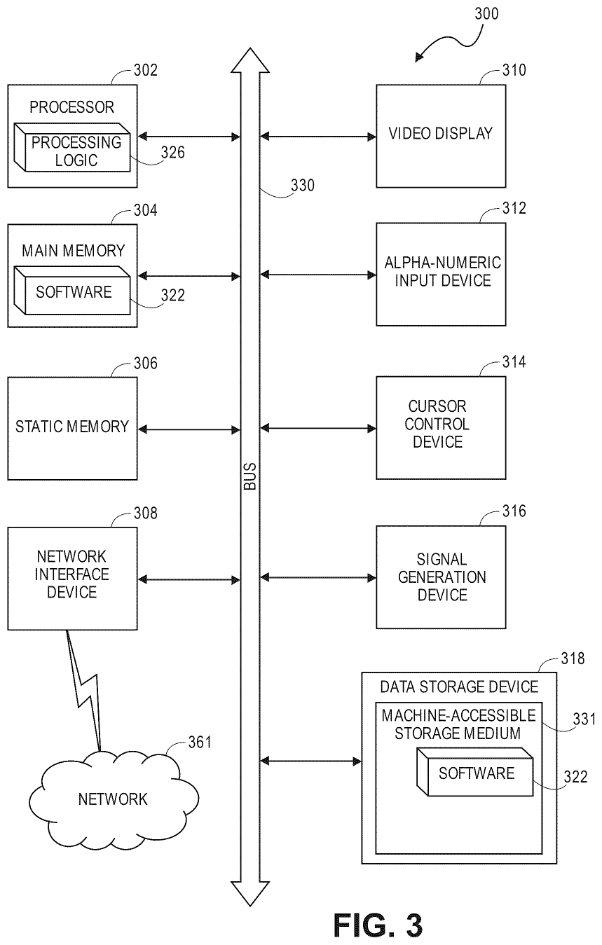

Referring now to FIG. 3, a block diagram of an exemplary computer system 300 of a processing tool is illustrated in accordance with an embodiment. In an embodiment, computer system 300 is coupled to and controls processing in the processing tool. Computer system 300 may be connected (e.g., networked) to other machines in a Local Area Network (LAN), an intranet, an extranet, or the Internet. Computer system 300 may operate in the capacity of a server or a client machine in a client-server network environment, or as a peer machine in a peer-to-peer (or distributed) network environment. Computer system 300 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 300, the term “machine” shall also be taken to include any collection of machines (e.g., computers) that individually or jointly execute a set (or multiple sets) of instructions to perform any one or more of the methodologies described herein.

Computer system 300 may include a computer program product, or software 322, having a non-transitory machine-readable medium having stored thereon instructions, which may be used to program computer system 300 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 300 includes a system processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a secondary memory 318 (e.g., a data storage device), which communicate with each other via a bus 330.

System processor 302 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 302 may also be one or more special-purpose processing devices such as an application specific integrated circuit (ASIC), a field programmable gate array (FPGA), a digital signal system processor (DSP), network system processor, or the like. System processor 302 is configured to execute the processing logic 326 for performing the operations described herein.

The computer system 300 may further include a system network interface device 308 for communicating with other devices or machines. The computer system 300 may also include a video display unit 310 (e.g., a liquid crystal display (LCD), a light emitting diode display (LED), or a cathode ray tube (CRT)), an alphanumeric input device 312 (e.g., a keyboard), a cursor control device 314 (e.g., a mouse), and a signal generation device 316 (e.g., a speaker).

The secondary memory 318 may include a machine-accessible storage medium 331 (or more specifically a computer-readable storage medium) on which is stored one or more sets of instructions (e.g., software 322) embodying any one or more of the methodologies or functions described herein. The software 322 may also reside, completely or at least partially, within the main memory 304 and/or within the system processor 302 during execution thereof by the computer system 300, the main memory 304 and the system processor 302 also constituting machine-readable storage media. The software 322 may further be transmitted or received over a network 361 via the system network interface device 308. In an embodiment, the network interface device 308 may operate using RF coupling, optical coupling, acoustic coupling, or inductive coupling.

While the machine-accessible storage medium 331 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. An apparatus, comprising:
a laser module that comprises:
a laser configured to emit a laser beam at a first wavelength and a first pulse width;
a pulse width temporal compressor optically coupled to the laser, wherein the pulse width temporal compressor is configured to reduce the first pulse width of the laser beam to a second pulse width that is shorter than the first pulse width;
a hollow core fiber optically coupled to the pulse width temporal compressor, wherein the hollow core fiber is configured to be filled with a gas, and wherein the laser beam is configured to generate a resonant dispersive wave with a second wavelength that is shorter than the first wavelength; and
an optical detector.

2. The apparatus of claim 1, wherein the second wavelength is less than 400 nm.

3. The apparatus of claim 1, wherein a pressure of the gas in the hollow core fiber is controlled to between 0.1 bar and 5.0 bar.

4. The apparatus of claim 1, wherein the pulse width temporal compressor comprises one or more of a multi-pass cell, a multi-plate cell, a series of chirped mirrors, and/or a second hollow core fiber.

5. The apparatus of claim 1, wherein a pulse width of the laser beam leaving the pulse width temporal compressor is approximately 20 fs or shorter.

6. The apparatus of claim 1, wherein the laser module further comprises:
a second harmonic generator (SHG) optically coupled to an output of the hollow core fiber.

7. The apparatus of claim 1, wherein the laser module is optically coupled to a chamber.

8. The apparatus of claim 7, wherein the laser module further comprises:
a prism compressor optically coupled between the laser module and the chamber.

9. The apparatus of claim 7, wherein the optical detector is optically coupled to the chamber by an optical fiber.

10. The apparatus of claim 7, wherein the optical detector is one of a plurality of optical detectors that are optically coupled to the chamber.

11. A processing tool, comprising:
a chamber; and
a two-photon absorption laser induced fluorescence (TALIF) sensor optically coupled to the chamber, wherein the TALIF sensor comprises:
a laser module configured to emit a laser beam with a tunable wavelength, wherein the laser module comprises:
a laser;
a laser pulse width temporal compressor;
a hollow core fiber, wherein the hollow core fiber is configured to be filled with a gas; and
an optical detector.

12. The processing tool of claim 11, wherein the TALIF sensor comprises a plurality of optical detectors around the chamber.

13. The processing tool of claim 11, wherein the optical detector is optically coupled to the chamber by a plurality of optical fibers that are distributed about a perimeter of the chamber.

14. The processing tool of claim 13, wherein the plurality of optical fibers comprise different lengths.

15. The processing tool of claim 11, wherein the laser is configured to output the laser beam with a first wavelength, and wherein the hollow core fiber is configured to emit a resonant dispersive wave of the laser beam, wherein the resonant dispersive wave has a second wavelength is less than 400 nm.

16. The processing tool of claim 15, wherein the second wavelength is tuned to provide two-photon absorption transitions for radicals of one or more of H, N, O, Cl, F, or Br.

17. The processing tool of claim 11, further comprising:
a probe laser optically coupled to the chamber; and
a spectrometer optically coupled to the probe laser with the chamber optically between the spectrometer and the probe laser.

18. A processing tool, comprising:
a chamber; and
a two-photon absorption laser induced fluorescence (TALIF) sensor coupled to the chamber, wherein the TALIF sensor comprises:
a laser module that is configured to emit a tunable laser beam with a wavelength that is less than 400 nm and a pulse width that is less than 20 fs; and
an optical detector.

19. The processing tool of claim 18, wherein the laser module comprises a gas filled hollow core fiber.

20. The processing tool of claim 18, wherein the laser module comprises a pulse width temporal compressor.
